(19) United States
(12) Patent Application Publication
(10) Pub. No.: US 2020/0406703 A1
(43) Pub. Date: Dec. 31, 2020

(54) AIR MIXING DEVICE OF VEHICLE HVAC MODULE, AND HVAC MODULE INCLUDING SAME

(71) Applicant: ESTRA AUTOMOTIVE SYSTEMS CO., LTD., Daegu (KR)

(72) Inventors: Jae Ho JEONG, Daegu (KR); Jae Chang PARK, Daegu (KR); Jin Hwa KIM, Daegu (KR)

(73) Assignee: ESTRA AUTOMOTIVE SYSTEMS CO., LTD., Daegu (KR)

(21) Appl. No.: 16/756,994

(22) PCT Filed: Oct. 19, 2017
(86) PCT No.: PCT/KR2017/011584

§ 371 Date: Apr. 17, 2020

(51) Int. Cl. B60H 1/00

(52) U.S. Cl. CPC B60H 1/00064; B60H 2001/00092

(57) ABSTRACT

An air mixing device that is arranged in a space where hot air passing through a heater core of an HVAC module and cold air passing through an evaporator core converge to mix the warm air and the cold air includes: a plurality of warm air guide tubes respectively forming a warm air guide passage for guiding the warm air to a defrost outlet; a first cold air guide provided on a downstream side of the warm air guide tube so that a cold air guide passage guiding the cold air to a vent outlet and a foot outlet is formed between the warm air guide tubes; and a second cold air guide installed to divide air flow through the cold air guide passage. The warm air guide tube is provided with a warm air branching window formed such that a portion of the warm air flowing through the warm air guide passage is branched and mixed with the cold air passing through the cold air guide passage.

### TECHNICAL FIELD

The present invention relates to an air mixing device of an HVAC (heating, ventilation and air-conditioning) module for vehicles and an HVAC module including same.

### BACKGROUND ART

An HVAC module of a vehicle has a heater core and an evaporator core inside, and controls the temperature of air by appropriately mixing heated air passing through the heater core and cooled air passing through the evaporator core and functions to distribute the temperature-controlled air to each outlet, such as a foot outlet, a vent outlet, and a defrost outlet, to send it to a required place inside a passenger compartment of the vehicle. For these air temperature control and flow control functions, the HVAC module includes an air passage, a valve, and the like.

There is a need to mix different air flows so that air of different temperature is discharged to each outlet, but it is difficult to achieve this by only controlling the air flow inside the HAVC module. For example, because the cooled air does not pass through the heater core, it has a higher velocity than the heated air so that it tends to push out the heated air even when it meets the heated air, so the cooled air pushes the heated air toward the foot outlet so that the high-temperature air is discharged only through the foot outlet and cold air is discharged within a certain time after operation through the vent outlet and defrost outlet. That is, when there is a cold air flow through the vent outlet and the defrost outlet, there is a problem that it is not easy to mix the heated air and discharge the mixed air.

In order to solve this problem, a technique has been introduced in which an air mixing device is disposed in a region where cold air and hot air are converged in an HVAC module so that cold air and hot air are properly mixed. Japanese Patent No. 4172013 introduces a technique in which a warm air guide groove is provided for guiding warm air passing through a heater core to a defrost outlet, and a cold air guide is arranged in a cold air through hole that extends in a direction substantially perpendicular thereto. However, in the air mixing device of Japanese Patent No. 4172013, since the passage for guiding the warm air has a form of a groove in which one side thereof is completely open, there is a problem in that the warm air escapes over the entire length of the warm air guide by the cold air flow passing between the warm air guides. Accordingly, there is a problem in that sufficient amount of the warm air cannot be discharged through the defrost outlet and the vent outlet.
Prior art document: Japanese patent No. 4172013 (registration date: 2008.08.20)

### DETAILED DESCRIPTION OF THE INVENTION

### Technical Problem

The present invention has been made to solve the above-mentioned problems, and the problem to be solved by the present invention is to provide an air mixing device capable of smoothly discharging warm air through a defrost outlet and a vent outlet.

In addition, another problem to be solved by the present invention is to provide an air mixing device capable of effectively mixing warm air and cold air and thereby allowing detailed temperature control for each mode.

### Technical Solution

In an exemplary embodiment of the present invention, an air mixing device that is arranged in a space where hot air passing through a heater core of an HVAC module and cold air passing through an evaporator core converge to mix the warm air and the cold air includes: a plurality of warm air guide tubes respectively forming a warm air guide passage for guiding the warm air to a defrost outlet; a first cold air guide provided on a downstream side of the warm air guide tube so that a cold air guide passage guiding the cold air to a vent outlet and a foot outlet is formed between the warm air guide tubes; and a second cold air guide installed to divide air flow through the cold air guide passage. The warm air guide tube is provided with a warm air branching window formed such that a portion of the warm air flowing through the warm air guide passage is branched and mixed with the cold air passing through the cold air guide passage.

The warm air branching window may be formed on a surface corresponding to a downstream side of the cold air guide passage among surfaces of the warm air guide tube.

The vent outlet and the foot outlet may be arranged on opposite sides relative to the second cold air guide, and the warm air branching window may be positioned on a side toward the vent outlet relative to the second cold air guide.

The air mixing device according to another embodiment of the present invention may further include a warm air guide plate that is disposed on an upstream side of the warm air guide tube to guide flow of warm air that has not flowed into the warm air guide tube.

An HVAC module for a vehicle according to an exemplary embodiment of the present invention includes: a housing; a heater core that is disposed in the housing and is configured to heat air to generate warm air; an evaporator core that disposed in the housing and is configured to cool air to generate cold air; an air mixing device that is disposed in a space where the warm air passing through the heater core and the cold air passing through the evaporator core converge to mix the warm air and the cold air; and one or more valves that control the air passing through the air mixing device to be discharged to one or more of a defrost outlet, a vent outlet and a foot outlet. The air mixing device includes: a plurality of warm air guide tubes respectively forming a warm air guide passage for guiding the warm air to a defrost outlet; a first cold air guide provided on a downstream side of the warm air guide tube so that a cold air guide passage guiding the cold air to a vent outlet and a foot outlet is formed between the warm air guide tubes; and a second cold air guide installed to divide air flow through the cold air guide passage. The warm air guide tube is provided with a warm air branching window formed such that a portion of the warm air flowing through the warm air guide passage is branched and mixed with the cold air passing through the cold air guide passage.

### Effect of the Invention

According to the present invention, a passage for guiding warm air in the air mixing device of the HVAC module is formed by a tube-shaped member and a warm air branching window is formed on the tube-shaped member, so that the warm air can be effectively moved toward the defrost outlet and at the same time the supply of warm air to the vent outlet and the foot outlet can be made smoothly.

### BRIEF DESCRIPTION OF DRAWINGS

FIG. 1 is a schematic perspective view of an HVAC module according to an embodiment of the present invention.

FIG. 2 is a cross-sectional view taken along a line II-II of FIG. 1.

FIG. 3 and FIG. 4 are perspective views of an air mixing device according to an embodiment of the present invention.

FIG. 5 is a view showing air flow when the HVAC module according to an embodiment of the present invention operates in a vent mode.

FIG. 6 is a view showing air flow when the HVAC module according to an embodiment of the present invention operates in a bi-level mode.

FIG. 7 is a view showing air flow when the HVAC module according to an embodiment of the present invention operates in a foot mode or a defog mode.

FIG. 8 is a view showing air flow when the HVAC module according to an embodiment of the present invention operates in a defrost mode.

### DETAILED DESCRIPTION OF EMBODIMENTS

Hereinafter, embodiments of the present invention will be described in detail with reference to the accompanying drawings.

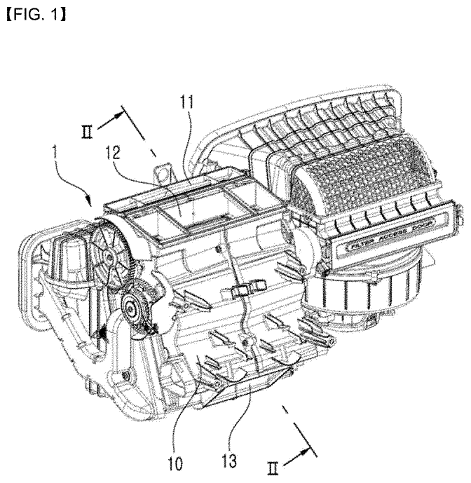

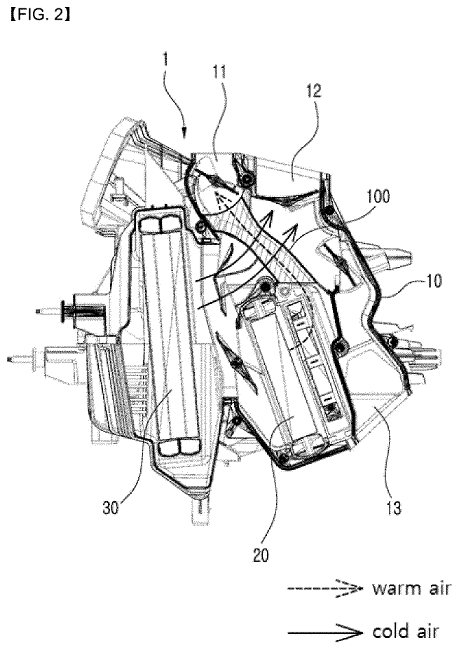

FIG. 1 and FIG. 2, an HVAC module 1 according to an embodiment of the present invention includes a housing 10. The housing 10 is formed to accommodate each of the components described below and is formed to receive and discharge exterior air or interior air in a passenger compartment. For example, the housing 10 may include a defrost outlet 11, a vent outlet 12 and a foot outlet 13.

A heater core 20 and an evaporator core 30 are disposed within the housing 10. The heater core 20 and the evaporator core 30 are respectively disposed in a passage through which air introduced into the housing 10 flows, and the heater core 20 functions to heat air and the evaporator core 30 functions to cool the air. Hereinafter, the air that has passed through the heater core 20 is called warm air, and the air that has passed through the evaporator core 30 is called cold air.

Meanwhile, an air mixing device 100 according to an embodiment of the present invention is disposed in a space where warm air passing through the heater core 20 and cold air passing through the evaporator core 30 converge to mix warm air and cold air. That is, warm air passing through the heater core 20 and cold air passing through the evaporator core 30 are moved to the air mixing device 100, respectively, and warm air and cold air are mixed by the air mixing device 100.

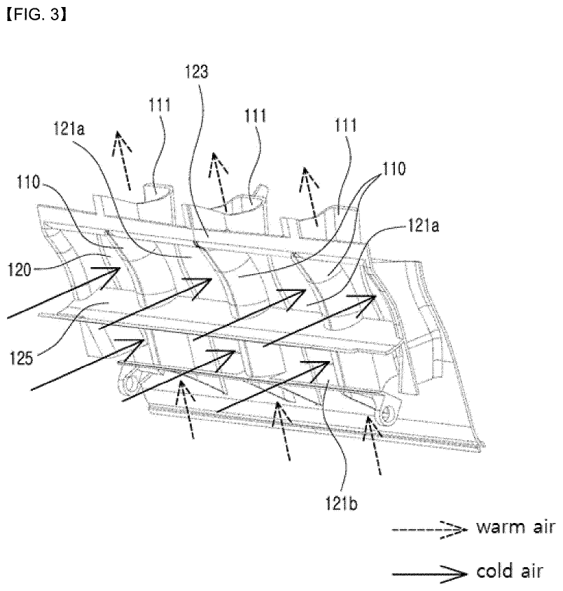

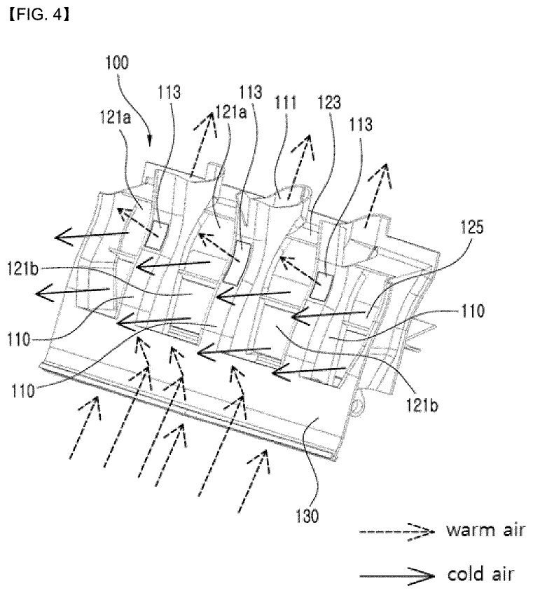

Hereinafter, the air mixing device 100 according to an embodiment of the present invention will be described in detail with reference to FIGS. 3 and 4. FIG. 3 is a perspective view seen from one point of the air mixing device and FIG. 4 is a perspective view seen from another point of the air mixing device. At this time, the left side of FIG. 3 corresponds to the left side of the air mixing device 100 illustrated in FIG. 2.

The air mixing device 100 includes a plurality of warm air guide tubes 110. Referring to FIG. 2 and FIG. 3, the plurality of warm air guide pipes 110 may be disposed adjacent to each other at intervals.

Each warm air guide tube 110 forms a warm air guide passage 111 that guides warm air to the defrost outlet 11. For example, the warm air guide tube 110 may be formed to extend from a side toward the heater core 20 to a side toward the defrost discharge port 11, whereby the warm air discharged from the heater core 20 can be discharged to the defrost discharge port 11 via the warm air guide passage 111 in the warm air guide tube 110 as shown in the dashed arrows in FIGS. 2 to 4.

Cold air guide passages 121a and 121b are formed between the warm air guide tubes 110. The cold air guide passages 121a and 121b serve to guide the cold air that has passed through the evaporator core 30 to the vent outlet 12 and the foot outlet 13. At this time, as shown in FIGS. 2 and 3, a first cold air guide 123 is provided on the downstream side of the warm air guide tube 110. That is, the space between the warm air guide tubes 110 and the first cold air guide 123 becomes the cold air guide passages 121a and 121b.

A second cold air guide 125 is provided for dividing the cold air guide passages 121a and 121b. That is, the cold air guide passage indicated by the reference numeral 121a and the cold air guide passage indicated by the reference numeral 121b are divided by the second cold air guide 125. As shown in FIG. 3 and FIG. 4, the second cold air guide 125 may be provided at a center of the warm air guide tube 110, and the cold air flowing through the cold air guide passage 121 is divided by the second cold air guide 125. At this time, the second cold air guide 125 may be provided on the upstream side (left side in FIG. 3) among the upstream and downstream sides of the cold air guide passage 121.

The warm air guide tube 110 includes a warm air branching window 113 that is formed such that a portion of warm air flowing through the warm air guide passage 111 is branched and mixed with cold air that has passed through the cold air guide passage 121. At this time, as shown in FIG. 4, the warm air branching window 113 may be formed in a surface corresponding to the downstream side of the cold air guide passages 121a and 121b (that is, the left side surface in FIG. 4) among the surfaces of the warm air guide tube 110. For example, the warm air branching window 113 may have a rectangular shape.

Due to the warm air branching window 113, a portion of the warm air flowing through the warm air guide passage 111 can be branched and mixed with the cold air without interfering with the movement of the warm air flowing to the defrost outlet 11. In particular, since the warm air guide tube 110 has a tube shape and the warm air branching window 113 is formed in the form of a window, stable flow of the warm air can be obtained and at the same time the mixing of warm air and cold air can be accurately controlled.

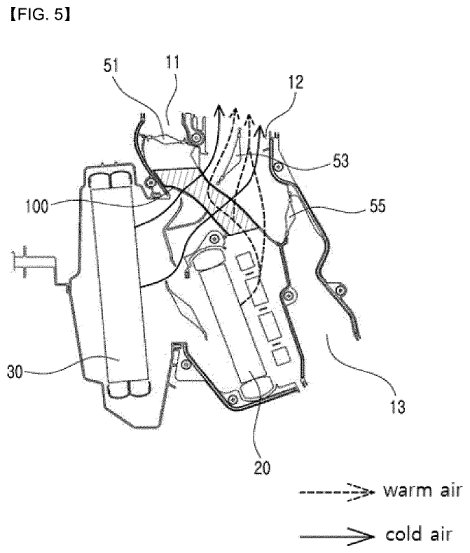

In this case, referring to FIGS. 2 and 5, a vent outlet 12 and a foot outlet 13 are disposed on opposite sides relative to the air mixing device 100, more specifically, the second cold air guide 125, and the warm air branch window 113 is disposed on the side toward the vent discharge port 112 relative to the second cold air guide 125. On the contrary, if the warm air branch window 113 is disposed on the side toward the foot outlet 113 relative to the second cold wind guide 125, the warm air discharged through the warm air branch window 113 is pushed by the cold air discharged through the cold air guide passage 121 so that it is difficult for the warm air to flow into the vent outlet 12. In the embodiment of the present invention, the warm air branching window 113 is disposed on the side toward the vent outlet 112 relative to the second cold air guide 125, so that the warm air discharged from the warm air branching window 113 is pushed by the cold air discharged through the cold air guide passage 121a that is disposed at the downstream side of the warm air guide tube 110 so as to smoothly move to the vent outlet 12. In addition, as the warm air hitting a warm air guide plate 130 is mixed with the cold air discharged from the cold air guide passage 121b, the mixed air flow to the foot outlet 13 may be formed.

Meanwhile, the warm air guide plate 130 is provided on the upstream side of the warm air guide tube 110. A portion of the warm air that has passed through the heater core 20 flows into the warm air guide tube 110 and the remaining portion thereof moves along the outer surface of the warm air guide plate 130.

Referring to FIG. 5, valves 51, 53 and 55 for regulating air flow in the HVAC module 1 may be provided. The valve indicated by the reference numeral 51 is a defrost valve for controlling the opening and closing of the defrost outlet 11, the valve indicated by the reference numeral 53 is a vent valve for controlling the opening and closing of the vent outlet 12, and the valve indicated by the reference numeral 55 is a foot valve for controlling the opening and closing of the foot outlet 13.

Hereinafter, air flows when the HVAC module according to the embodiment of the present invention operates in various modes will be described with reference to FIGS. 5 to 8.

First, FIG. 5 is a view showing air flow when the HVAC module according to an embodiment of the present invention operates in a vent mode. As shown in FIG. 5, if the defrost valve 51 and the foot valve 55 are closed and the vent valve 53 is opened, the warm air passing through the heater core 20 is discharged through the warm air branching window 113 and the cold air passing through the evaporator core 30 is discharged through the cold air guide passages 121a and 121b. At this time, the cold air passing through the cold air guide passages 121a and 121b encloses the warm air discharged through the warm air branching window 113 from both sides and the warm air moving along the warm air guide plate 130 is mixed with it, and accordingly the warm air and the cool air are well mixed and discharged to the vent outlet 12.

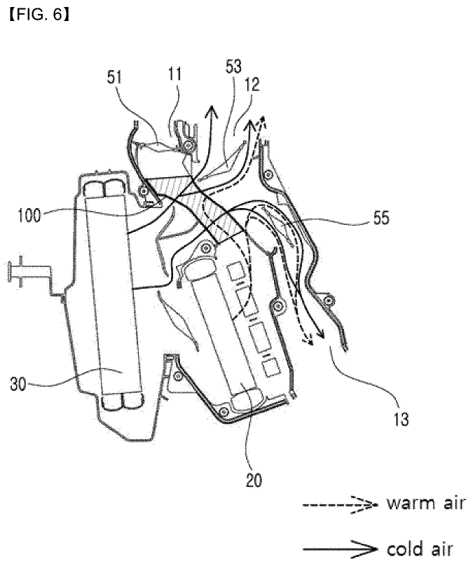

FIG. 6 is a view showing air flow when the HVAC module according to an embodiment of the present invention operates in a bi-level mode. As shown in FIG. 6, if the defrost valve 51 is closed and the vent valve 53 and the foot valve 55 are opened, the warm air passing through the warm air branching window 113 is pushed by the cold air passing through the cold air guide passage 121a to be mixed therewith and is then discharged to the vent outlet 12, and the warm air moving along the warm air guide plate 130 is pushed by the cold air passing through the cold air guide passage 121b to be mixed therewith and is then discharged to the foot outlet 13.

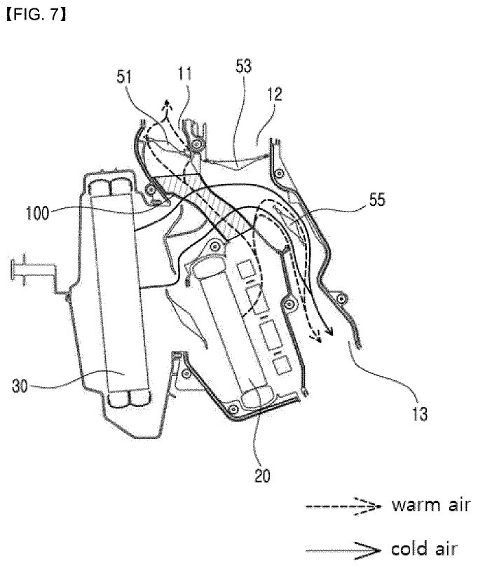

FIG. 7 is a view showing air flow when the HVAC module according to an embodiment of the present invention operates in a foot mode or a defog mode. As shown in FIG. 7, if the defrost valve 51 and the foot valve 55 are opened and the vent valve 53 is closed, the warm air flowing through the warm air guide passage 111 is discharged to the defrost outlet 11 and the warm air moving along the warm air guide plate 130 is mixed with the cold air discharged through the cold air guide passages 121a and 121b and is then discharged to the foot outlet 13.

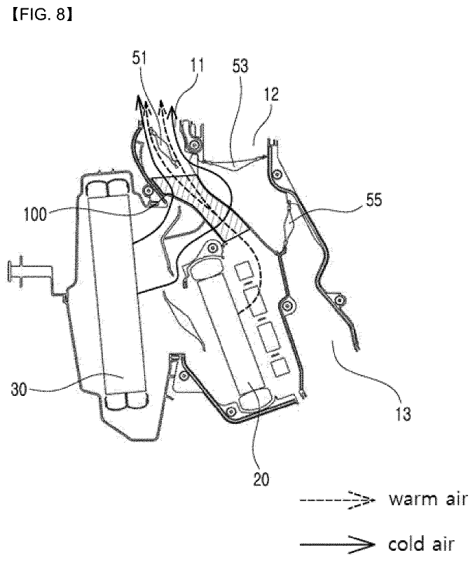

FIG. 8 is a view showing air flow when the HVAC module according to an embodiment of the present invention operates in a defrost mode. As shown in FIG. 8, if the defrost valve 51 is opened and the vent valve 53 and the foot valve 55 are closed, the warm air flowing through the warm air guide passage 111 and the cold air flowing through the cold air guide passages 121a and 121b are mixed with each other and are then discharged to the defrost discharge port 11. At this time, a portion of the warm air flowing outside the warm air guide tube 110 may move along the first cold air guide 123 to be discharged to the defrost discharge port 11.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The present invention can be used in an air conditioning device of a vehicle, so it has an industrial applicability.

1. An air mixing device that is arranged in a space where hot air passing through a heater core of an HVAC module and cold air passing through an evaporator core converge to mix the warm air and the cold air, comprising:
a plurality of warm air guide tubes respectively forming a warm air guide passage for guiding the warm air to a defrost outlet;
a first cold air guide provided on a downstream side of the warm air guide tube so that a cold air guide passage guiding the cold air to a vent outlet and a foot outlet is formed between the warm air guide tubes; and
a second cold air guide installed to divide air flow through the cold air guide passage,
wherein the warm air guide tube is provided with a warm air branching window formed such that a portion of the warm air flowing through the warm air guide passage is branched and mixed with the cold air passing through the cold air guide passage.

2. The air mixing device of claim 1, wherein the warm air branching window is formed on a surface corresponding to a downstream side of the cold air guide passage among surfaces of the warm air guide tube.

3. The air mixing device of claim 2, wherein the vent outlet and the foot outlet are arranged on opposite sides relative to the second cold air guide, and wherein the warm air branching window is positioned on a side toward the vent outlet relative to the second cold air guide.

4. The air mixing device of claim 1, further comprising a warm air guide plate that is disposed on an upstream side of the warm air guide tube to guide flow of warm air that has not flowed into the warm air guide tube.

5. An HVAC module for a vehicle comprising:
a housing;
a heater core that is disposed in the housing and is configured to heat air to generate warm air;
an evaporator core that disposed in the housing and is configured to cool air to generate cold air;
an air mixing device that is disposed in a space where the warm air passing through the heater core and the cold air passing through the evaporator core converge to mix the warm air and the cold air; and
one or more valves that control the air passing through the air mixing device to be discharged to one or more of a defrost outlet, a vent outlet and a foot outlet,
wherein the air mixing device comprises:
a plurality of warm air guide tubes respectively forming a warm air guide passage for guiding the warm air to a defrost outlet;
a first cold air guide provided on a downstream side of the warm air guide tube so that a cold air guide passage guiding the cold air to a vent outlet and a foot outlet is formed between the warm air guide tubes; and
a second cold air guide installed to divide air flow through the cold air guide passage,
wherein the warm air guide tube is provided with a warm air branching window formed such that a portion of the warm air flowing through the warm air guide passage is branched and mixed with the cold air passing through the cold air guide passage.

6. The HVAC module for a vehicle claim 5, wherein the warm air branching window is formed on a surface corresponding to a downstream side of the cold air guide passage among surfaces of the warm air guide tube.

7. The HVAC module for a vehicle claim 6, wherein the vent outlet and the foot outlet are arranged on opposite sides relative to the second cold air guide, and wherein the warm air branching window is positioned on a side toward the vent outlet relative to the second cold air guide.

8. The HVAC module for a vehicle claim 5, wherein the air mixing device further comprises a warm air guide plate that is disposed on an upstream side of the warm air guide tube to guide flow of warm air that has not flowed into the warm air guide tube.

9. An air mixing device that is arranged in a space where hot air passing through a heater core of an HVAC module and cold air passing through an evaporator core converge to mix the warm air and the cold air, comprising:
a plurality of warm air guide tubes respectively forming a warm air guide passage for guiding the warm air to a defrost outlet;
a first cold air guide provided on a downstream side of the warm air guide tube so that a cold air guide passage guiding the cold air to a vent outlet and a foot outlet is formed between the warm air guide tubes;
a second cold air guide installed to divide air flow through the cold air guide passage; and
a warm air guide plate that is disposed on an upstream side of the warm air guide tube to guide flow of warm air that has not flowed into the warm air guide tube at a downstream side of the cold air guide passage,
wherein the warm air guide tube is provided with a warm air branching window formed such that a portion of the warm air flowing through the warm air guide passage is branched and mixed with the cold air passing through the cold air guide passage,
wherein the vent outlet and the foot outlet are arranged on opposite sides relative to the second cold air guide,
wherein the warm air branching window is formed on a surface corresponding to a downstream side of the cold air guide passage among the surfaces of the warm air guide tube and is located at a side toward the vent outlet with respect to the second cold air guide, thereby being configured such that the warm air discharged through the warm air branching window is mixed with the cold air that has passed through a passage at a side toward the vent outlet among both sides of the second cold air guide,
and wherein the warm air guide plate is configured such that the guided warm air is mixed with the cold air that has passed through a passage at a side toward the foot outlet among both sides of the second cold air guide.

10. An HVAC module for a vehicle comprising:
a housing;
a heater core that is disposed in the housing and is configured to heat air to generate warm air;
an evaporator core that disposed in the housing and is configured to cool air to generate cold air;
an air mixing device that is disposed in a space where the warm air passing through the heater core and the cold air passing through the evaporator core converge to mix the warm air and the cold air; and
one or more valves that control the air passing through the air mixing device to be discharged to one or more of a defrost outlet, a vent outlet and a foot outlet,
wherein the air mixing device comprises:
a plurality of warm air guide tubes respectively forming a warm air guide passage for guiding the warm air to a defrost outlet;
a first cold air guide provided on a downstream side of the warm air guide tube so that a cold air guide passage guiding the cold air to a vent outlet and a foot outlet is formed between the warm air guide tubes;
a second cold air guide installed to divide air flow through the cold air guide passage; and
a warm air guide plate that is disposed on an upstream side of the warm air guide tube to guide flow of warm air that has not flowed into the warm air guide tube at a downstream side of the cold air guide passage,
wherein the warm air guide tube is provided with a warm air branching window formed such that a portion of the warm air flowing through the warm air guide passage is branched and mixed with the cold air passing through the cold air guide passage,
wherein the vent outlet and the foot outlet are arranged on opposite sides relative to the second cold air guide,
wherein the warm air branching window is formed on a surface corresponding to a downstream side of the cold air guide passage among the surfaces of the warm air guide tube and is located at a side toward the vent outlet with respect to the second cold air guide, thereby being configured such that the warm air discharged through the warm air branching window is mixed with the cold air that has passed through a passage at a side toward the vent outlet among both sides of the second cold air guide,
and wherein the warm air guide plate is configured such that the guided warm air is mixed with the cold air that has passed through a passage at a side toward the foot outlet among both sides of the second cold air guide.
